(19) United States
(12) Patent Application Publication
(10) Pub. No.: US 2007/0038494 A1
(43) Pub. Date: Feb. 15, 2007

(54) Team management system and method

(75) Inventors: Charles B. Kreitzberg, Princeton Junction, NJ (US); Anne Pauker Kreitzberg, Princeton Junction, NJ (US); Whitney Quesenbery, High Bridge, NJ (US); Lori J. Caruso, Iselin, NJ (US)

Correspondence Address: ALTIMATIA, L.L.C., 16 ELM RIDGE ROAD, PENNINGTON, NJ, 08534, US

(73) Assignee: Cognetics Corporation, Princeton Junction, NJ (US)

(21) Appl. No.: 11/203,759

(22) Filed: Aug. 15, 2005

(51) Int. Cl. G06F 9/46

(52) U.S. Cl. 705/8

(57) ABSTRACT

A system and a method for managing teams engaged in projects by improving team communications, organizing and directing team workflow, and improving individual and team performance is disclosed. Embodiments of the invention are n-tiered systems comprising a data storage component running on one or more servers, a business rules component running on one or more servers, and a user interaction component running on a user interaction device. The components may be connected via a wired or wireless network, or they may reside on a single machine. Embodiments of the invention use dashboards comprising graphic symbols and/or colors to provide a multi-project view, allowing a user to quickly comprehend the status of multiple projects. Embodiments of the invention support the storage and retrieval of qualitative and quantitative information related to project and team management.

### FIELD OF THE INVENTION

The present invention generally relates to an improved system and method for managing teams engaged in projects.

### BACKGROUND

The efficient functioning of management teams is key to the efficient functioning of an organization. Research confirms that well-managed teams are twice as efficient and profitable as less well-managed teams. While many factors can affect how well teams perform, two critical factors are:

1. effective communications among team members

2. availability of crucial information, when it is needed at the right level of detail

Two important types are management teams and project teams. A management team is a team that is responsible for managing a group of projects. A project team is responsible for executing a specific project. The leader of a project team, the project lead, is typically a member of the management team.

Effective management requires three types of communication for project leads:

1. “upward communication” to the management team leader that has overall responsibility for multiple projects

2. “lateral communication” to peers on the management team, and

3. “downward communication” to the project team that is responsible for execution of a specific project and its completion on time, on budget and with the anticipated results.

Note that the terms “upward,” “downward,” and “lateral” simply reflect the direction of the communication on a typical organization chart.

Effective communication also requires that:

1. The information to be communicated is readily available

2. The channels for communication are appropriate.

3. The information can be communicated in a form that is clear and comprehensible to all parties in the communication.

Typically organizations rely on informal systems, or paper-based systems for management team communications. They may be equally informal when it comes to managing the project team or they may use project management systems to manage tasks, resources, and track projects at the project level.

At the project team level, project management systems such as Microsoft Project or the system disclosed in US Patent Application Publication 2003/0061330 are often used to support the project lead. Project management systems assist with the complex scheduling processes required in large complicated projects. Timelines may be created and completion dates estimated. The systems are often linked to cost accounting systems to track labor costs, material costs, and overall budget. The labor involved in setting up the project plan is considerable and the effort involved in project tracking is high. When the project plan needs to change to respond to shifting conditions there may be problems. Project management systems often lack the flexibility to rapidly make the adjustments needed, especially in projects that are not highly structured.

Project management systems are not oriented to providing a management team with a high-level picture of the project's progress nor do they make it easy record and respond to qualitative factors such as issues that arise, changes in the environment, or feedback from customers or other stakeholders.

Project management systems do not support management teams in such critical areas as strengthening relationships among team members, facilitating the decision-making process, identifying issues that impede progress and identifying resources that can be brought in to address specific needs.

Another type of system, typically focused on the needs of the members of a project team, is the collaboration tool, also called a team room. A number of collaboration tools exist that may be adapted to team management. For example US patent application publications 2004/0207249, 2003/0028595, and 2003/0097410 and U.S. Pat. No. 6,769,013 disclose such collaboration systems. These systems allow a group of individuals to communicate via a computer network, and to come together to communicate, brainstorm, and solve problems. While helpful for fostering collaboration and problem solving in the context of a particular project, such systems do not provide the structured, comprehensive, and high-level, cross-project information needed by the management team responsible for multiple projects. They also do not provide a context for sharing resources and information across disparate projects.

Other methods used to manage project teams include the use of electronic mail trails, spreadsheets, and simple databases. An electronic mail trail, a concatenation of electronic mail messages cataloging the progress of a project or task can provide a journal-like history of a project. Spreadsheets, or simple databases, such as flat file databases may be used to track projects, associated project tasks, timelines, and budgets. Such systems may support project management if users are diligent about data entry, but the systems lack a structure that supports effective decision-making. In addition, such methods do not ensure that the data entered are comprehensive and up to date.

Data sharing with electronic mail, spreadsheets, and simple databases is problematic since sharing must often be accomplished by making copies of the relevant files. After a time multiple copies of the files may exist and users will have difficulty determining which is the most current version of a file. Going back to determine the past state of a project can be difficult because it requires locating and assembling multiple documents.

Another type of tool that is often used to manage teams is the Personal Information Manager (PIM), also called personal organizers that organize information about an individual's activities. Examples of PIMs include paper-based systems built around ring binders with specially designed pages such as the well-known Fileofax product line. Such personal organizers are also implemented as hardware devices known as Personal Digital Assistant's (PDAs) and as software products that run on personal computers.

Organizers, whether implemented as binders, hardware or software, typically mange such information as goals, tasks, contacts, and schedule.

Personal organizers are not suitable for managing team activities. They are not designed to accept input from multiple users, whose members may be at different geographic locations. They also lack communication capabilities for upward, downward or lateral communication. Finally, personal organizers are built to track tasks, often called to-do lists, while in a team setting there is a need to track projects that are far more complex. In addition, the increased complexity of team organization requires more powerful tools for searching and organizing information that a personal organizer provides.

The systems described above, while useful in their respective spheres, fail to address the needs of the management team. The management team needs a high-level view across multiple projects. They need to be able to see the status and progress of each individual project at a glance as well as the state of the group of projects for which they have responsibility. They need to be able to look at multiple dimensions such as progress, finance, staffing, workload, customer feedback, issues requiring resolution, and the project plan, both for individual projects and across projects.

What is required is a team-level tool that organizes and presents all required data and that supports upward, lateral, and downward communication. The tool must provide a view of individual projects and groups of projects. It must have a comprehensive model for organizing data so that each individual project is fully represented and individual projects can be aggregated or compared. It must create a framework within which team members can communicate effectively. It must support the development of a shared vision among team members.

The tool should be useful for goal setting, goal tracking, and issue management. The tool should allow users to view status at a glance for both individual projects and across multiple projects. When desired, it should allow users to drill down to obtain details on demand, thereby avoiding information overload while ensuring a comprehensive view of the high-level data. Such drill down capabilities would support problem solving and overall project understanding by users of the system. In addition, the system should be able to track project stages so that workflow may be managed. Another useful feature would be the use of graphic visualizations to allow users to rapidly comprehend the current state of a project or a group of projects. A project archiving capability would make completed or otherwise ended project information available to the management team so the users can learn from past projects and institutional memory is preserved. Because circumstances change constantly, the tool should offer an issue tracking system to identify issues that affect projects and track proposed actions to address them. The system should support the collection of qualitative project data, and also support customer interaction and feedback.

The tool should make it easy for project leads to input the desired information. It should help project leads become more proficient at identifying and articulating progress and issues and in proposing actions to deal with them. To this end, it should incorporate such tools as wizards and just-in-time training modules that can help users organize their data input so it is as relevant, clear, and concise as possible.

The tool should also support continuous improvement in the management team's performance. It should foster a shared vision and common language across the project management team so that the team can make more effective decisions and take effective action. Such a tool would help individual team members become more effective on a personal level and the team as a whole becomes more effective through a flexible and supportive process

The tool and its associated processes should provide the management team leader with documented information that supports evaluating individual team member performance and assists team members in developing their skills and competencies. The system should support the team leader in “rolling-up” and reporting to higher management.

Finally, the tool needs to be action oriented. It needs support identification of issues and concerns where action is required encourage the team to identify actions that will resolve such issues and concerns in a positive way, and track the results of such actions.

### BRIEF DESCRIPTION

It is an object of the invention to provide a system for managers, team leaders, and individual contributors to manage teams and projects. The invention supports people that are working on or with multiple projects, multiple teams, and multiple individual contributors. Embodiments of the invention assist communications and provide transparency, allowing everyone associated with a team to see what is occurring and to understand where their contribution to the project and organization fits. Embodiments of the invention are flexible and support project modifications during the execution of a project. While embodiments of the invention may be used with individual projects, they are designed to work with a plurality of projects and a plurality of project tasks within individual projects.

Embodiments of the invention are designed to be used by a wide variety of organizations comprising, for example, corporations, charitable organizations, task forcer committees, boards, associations, professors supervising students, and government organizations. The embodiments support a variety of management structures comprising, for example, hierarchical management structures, network management structures, and informal management structures. As shown in FIG. 1 a team may comprise the executive committee of a corporation, the global marketing group, or the US marketing group.

Embodiments of the invention comprise an n-tiered software system with a data storage component residing on a server or multiple servers, a business rules component connected to the data storage component, the business rules component residing on a server or multiple servers, and a user interaction component running on a client device connected to the business rules component and to the data storage component. The user interaction component may connect to the data storage component via the business rules component or it may connect directly to the data storage component. While the invention will typically comprise multiple machines, including servers, client computers, personal digital assistants, mobile telephones and the like, other embodiments of the invention may comprise a single machine. An exemplary architecture is shown in FIG. 3.

Communications between connected components of the invention may be provided by wired or wireless communication networks, such as provided by the internet or mobile telephones or wireless personal digital assistants. The use of a communication network to provide connections between components allows users to be located at multiple physical sites, including multiple buildings, multiple cities, multiple countries or all of the above. Communications between components may be plain or they may be encrypted.

The data storage component may comprise a database or other data storage means that supports the electronic storage and retrieval of information. The data storage component may comprise qualitative data such as comments, impressions, and concerns as well as quantitative data such as deliverables, key dates, financial data, and timeline data. The data storage component is configured to store project data, team data, and person data. Data stored within the system and communicated between components of the system may be compressed, or encrypted, or both compressed and encrypted. In addition to comprising qualitative data storage and quantitative data storage the data storage component may also comprise a document storage component. The document storage component may be combined with the component for storing qualitative data and quantitative data, or it may comprise a separate component.

Embodiments of the invention support document storage. Often documents such as contracts, specifications, user requirements, and other documents are associated with a project. The document storage component of the system supports the storage and retrieval of such documents.

Embodiments of the invention provide an archiving component. The archiving component supports the storage and retrieval of information related to completed or otherwise inactive projects. Such an archiving component can build institutional memory, allowing users of the system to learn from past projects.

The business rules component may be integrated with the data storage component or be separate from the data storage component. For example, the business rules component may comprise a program written in a programming language of a database or data storage component and be intimately associated with the database or data storage component. Alternatively, the business rules component may comprise a stand-alone program that communicates with the data storage component and the user interaction component. Such a stand-alone business rules component could be written in any standard programming language or scripting language such as C, C++, Visual Basic, Fortran, Perl, Java, JavaScript, or the like. A stand-alone business rules component may execute on the same server as the data storage component, the same device as the user interaction component, or it may run on its own server separate from a data storage component server and user interaction device. In another form, the business rules component may comprise rules contained within the user interaction component, running on the user interaction device. Finally, the business rules component may comprise a combination of the systems described above. Functions of the business rules component comprise qualitative and quantitative data tracking, project workflow tracking, issue tracking, action item tracking, goals tracking, project state tracking, project component status tracking,

Embodiments of the invention adapted to track qualitative data. Such data may be collected across all projects, within individual projects, and from individual contributors. Qualitative data may comprise text, voice, or other information related to projects, people, issues, timelines, budgets, project stages, project states, goals, and performance.

Embodiments of the invention are adapted to track quantitative data, such as data related to budgets, dates, and workload. Such data may be used to support decision making but are not required to be detailed enough to support a cost accounting function.

Embodiments of the invention are adapted to track project workflow. Project workflow stages may comprise inception or conception, planning, funded, active, executed, completed, awaiting post-completion evaluation, archived, cancelled, and on hold. The specific project workflow stages used by projects are defined by the system administrator during system configuration.

Embodiments of the invention are adapted to track project component status. The project component state may comprise one of several values: “severe” meaning the project component is in trouble, “moderate” meaning the project component is at risk, “ok” meaning the project component is on track, and “no activity” meaning the project component is not currently being pursued. The state values of project components may also be called severity values, severity indicator values.

Embodiments of the invention are adapted to track project status. The overall status of a project is a function of the status of the project components. Project components may comprise project progress, project issues, project key dates, project key tasks, and project budget.

Embodiments of the invention are adapted to track issues. As a project is pursued various problems or issues may arise. These issues may affect the completion of the project and these issues may need to be addressed by the team as a whole, or by a team leader, individual contributor, or others. The system supports the entry and tracking of issues from initial issue raise to final issue disposition. The system supports the assignment of issue state values. Issue state values may contribute to the determination of project state and status values.

Embodiments of the invention are adapted to track action items. Action item tracking allows users to create, assign, communicate about, modify, and monitor the results of actions and determine the need for further actions. The embodiments support the assignment of action item state values. Action item state values may contribute to the determination of project state and status values.

Embodiments of the invention are adapted to track and forecast user workload. Tracking and forecasting user workload assists the organization in utilizing labor in the most effective manner and helps avoid over-burdening team members with more tasks than they may effectively handle.

Embodiments of the invention are adapted to track goals. The goals may comprise project goals, personal goals, issue goals, task goals, or any goals that are relevant for the users of the system.

The user interaction component displays information and accepts user input. User input may comprise mouse clicks, key clicks from a keyboard, voice input, or handwritten input. User output may comprise web pages, text, graphics, video, and audio. The user interaction component may comprise a web browser, or it may comprise a user interaction program. Such a user interaction component may reside on a user interaction device. A user interaction device may comprise a client computer, personal digital assistant, mobile telephone, or other device that may connect to the other components of embodiments of the invention.

Embodiments of the invention comprise a multiple project view on a user interaction component, allowing the user to comprehend the state, stage, and status of a plurality of projects at once. The views may be standard views supported by the system or the views may be custom views created by users.

Embodiments of the invention comprise a search function. Such a search function may comprise a query input system and Boolean logic allowing complex queries to be formulated.

Embodiments of the invention provide multiple ways of viewing data. For example, in response to user query input, the system may provide information related to all projects where a user is the project lead, all projects where a project state or component state is severe, all projects where the user is a participant, all projects under budget, or all projects that are completed.

Embodiments of the invention use graphic symbols and/or colors to indicate the current state of a project and its components. The use of graphics allows a user to quickly grasp the current state of a project and its components. For example severity indicator data may be displayed in a dashboard through the use of graphic symbols and/or colors. Individual components of a project may comprise issues, actions, key dates, deliverables, tasks, budgets, workloads, and work stages. The graphic symbols may comprise symbols such as check marks, question marks, and crosses. The symbols may comprise colors. For example the colors red, yellow, and green may be used to indicate the importance of an issue, action, key date, task, budget, workload, work stage, state or project status.

Embodiments of the invention are adapted to provide drill down functionality allowing users to drill down to deeper levels of detail related to particular projects. For example, a user may notice that a project has an unresolved issue. The user may drill down by interacting with the user interaction component and learn the details of the issue, and other issue related information such as proposed strategy and action items.

Embodiments of the invention support the use of classes of team members and roles for users. Team, class, and roles may be defined by the system administrator during system configuration. Individuals associated with projects may be assigned to a class comprising employee, contractor, volunteer, or client and may assume one or more roles comprising project owner, project lead, controller, external relationship manager, project sales, project staff, or project administrator, client partner, client billing contact, or client project administrator.

Embodiments of the invention support customer feedback. Customer feedback can be entered by users of the system, or customers may provide feedback directly via an extranet. An extranet would allow customers to view a portion of the data relevant to their projects. Proprietary information would remain inaccessible.

Embodiments of the invention may comprise an electronic mail notification system. Such a system would use electronic mail to support communication between users of the system and the data storage component. When issues are identified, actions taken, reports written, status updated, contact information changed, or other actions performed, the system may provide notification via electronic mail or messaging. The user may send electronic mail to the system to store documents, update information, state, or status. The system may notify users of overdue states, status, reports, or upcoming key dates. A user may communicate with other users of the team management system and/or the data storage component via electronic mail to solicit suggestions, communicate results, provide weekly updates, or provide other information. The electronic mail system may also automatically send messages to users in response to internal or external triggers. The electronic mail system may also store messages sent or, or sent by, team members.

Embodiments of the invention comprise a contact manager. Such a system may comprise information related to individuals including electronic mail addresses, telephone numbers, mailing addresses, facsimile numbers, and other pertinent information.

Embodiments of the invention comprise wizards to assist users in learning to use the system. Such wizards may, for example, assist users with project creation, data entry, report generation, and goal setting.

Embodiments of the invention comprise a just in time training system, also called a performance support system. Such a system assists users to learn the preferred method of performing a task. For example a just-in-time training system may be invoked by a user during the preparation of a progress report. The system not only assists the user in learning the software, but also assists the user in learning the preferred way to perform a task. For example, the system make instruct the user on goal setting techniques or the preferred way to prepare a weekly report. The system may provide assistance to users in the form of written assistance, audio assistance, video assistance or may use a combination of two or more forms of assistance.

### DESCRIPTION OF THE DRAWINGS

FIG. 1 shows possible teams within the organizational structure of a corporation.

FIG. 2 shows a diagram of team organization

FIG. 3 shows a schematic of the hardware architecture of an embodiment of the invention.

FIG. 4 shows an object-relationship diagram of an embodiment of the invention.

FIG. 5 shows an object-relationship diagram of an embodiment of the invention.

FIG. 6 shows an object-relationship diagram of an embodiment of the invention.

FIG. 7 shows an object-relationship diagram of an embodiment of the invention.

FIG. 8 shows the relationship between status data and progress reports, issues, key tasks, and finance.

FIG. 9 illustrates the drill down process.

FIG. 10 illustrates the relationships between system elements.

FIG. 11 illustrates the updating process.

FIG. 12 shows a representative visualization.

FIG. 13 shows the Admin screen of In The Know!™.

FIG. 14 shows the Terminology screen, one level below the Admin screen.

FIG. 15 shows Add Project screen.

FIG. 16 shows a created project dashboard view.

FIG. 17 shows a created project summary view.

FIG. 18 shows the My Projects view.

FIG. 19 shows the My Goals view.

FIG. 20 shows the My tools view.

FIG. 21 shows an Action Item List view.

FIG. 22 shows the View or Edit Action Item screen.

FIG. 23 show the configuration of an Email notification.

FIG. 24 shows a Project dashboard.

FIG. 25 shows a Financial Dashboard.

FIG. 26 shows a Project summary screen.

FIG. 27 illustrates using a drop down menu to select a detail for drill down.

FIG. 28 shows the Issues detail view.

FIG. 29 shows the Staff Assignments detail view.

FIG. 30 shows the Key Dates detail view.

FIG. 31 shows the History detail view.

FIG. 32 shows the Document repository view.

FIG. 33 shows the Modifying project detail menu.

FIG. 34 shows Team goals screen.

FIG. 35 shows a Staff Directory.

FIG. 36 shows a Client Listing.

### DETAILED DESCRIPTION

The following terms used herein are defined as follows:

As used herein “comprise” means to include, to contain, to be made up of, in a non-exclusive, open-ended sense. A system comprised of components includes or contains those components, but may also contain or include other components.

As used herein ” computer readable medium” refers to CDROM, digital tapes, dynamic random access memory, static random access memory, memory cards, memory sticks, floppy disks, hard disks, DVD, or other media that can store information and be read or accessed by computers.

As used herein “team” refers to a group of individuals who are engaged in a common mission. Examples of teams include, but are not limited to, the executive committee of a corporation or business as shown in FIG. 1, the executive board of a professional organization, the executive board of a non-profit organization, a task force or committee, a product development group, a marketing staff as shown in FIG. 1, a creative design group, a department which is a portion of a larger organization. As used herein team also refers to a group of individuals who are pursuing individual goals while being coordinated by a leader. For example, a team may comprise a group of students working under the direction of a teacher or professor, or a group of entrepreneurs who are working to develop proposals while being assisted by venture capitalists. Team members may comprise individuals from outside an organization such as vendors, consultants, and others.

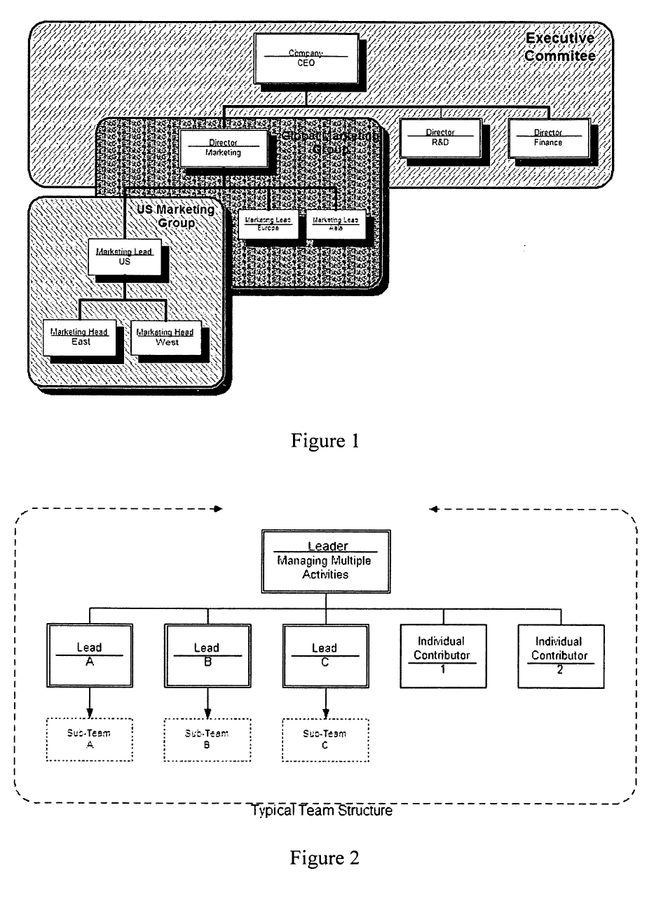

As used herein “team leader” refers to the person assigned the leadership function for the team, as shown in FIG. 2. The leader of a team is the individual responsible for overall management and coordination of the team's projects. The leader may be a supervisor and the team members may be the leader's direct reports; the leader may be first among equals such as the foreperson of a jury or the chair of an executive board; the leader may be a mentor such as a professor with students. Team members and leader may work in a hierarchical organizational structure, a matrixed organizational structure, or other organizational structure. It is also possible for teams to have multiple leaders, in which case each leader will have a defined area of responsibility as for example with law firm partners and accounting firm partners. Examples of different kinds of teams and team leaders include the following:

A sales director leading a team of regional managers. The regional sales managers report to the sales director, and each regional sales manager has a team of sales representatives.

A college professor managing a group of graduate students, each of whom is working a different research project.

A construction organization lead by a general manager who is responsible for managing three general contractors (leads) and two architects (individual contributors).

A township government comprising a Mayor and seven Council members.

An executive board comprising a President and a group of Board Members.

A task force comprising a chair and a number of managers and individual contributors.

A political campaign committee comprising a National Campaign Director and a group of representatives at the state level.

An ad-hoc political action group formed as the result of a web discussion and organized to protest a law that they do not like.

As used herein “management team members”, as shown in FIG. 2, are individuals assigned the responsibility for specific projects or aspects of projects. Team members may be managers who supervise individuals, sub-teams, work crews or manage other less formal structures. It is common for management team members to function as a project lead for one or more of their own project teams. Management Team members may also be individual contributors in which case the individual contributors are responsible for projects but do not formally manage the activities of others. Team members may work together in the same geographical area or they may be located geographically apart from one another.

As used herein “role” refers to the assigned part played by a team member. Team members play one or more roles with respect to a project. Any role may potentially be divided between more than one team member and any team member may take on multiple roles. The roles applied to a team are defined by the team during the initialization process of the system. Common roles comprise:
Owner—The individual or group with ultimate responsibility for the project. The owner of an project or activity is the individual or group with the authority to cancel the project or activity. The owner is often the executive sponsor.
Lead—The lead or project lead is the individual or group responsible for managing the work associated with the project. The project lead is often the project manager.
Controller—The controller is the individual or group responsible for tracking the financial status of the project. Either the controller or the owner may have responsibility for allocating financial and other resources to the initiative.
Relationship Manager—The relationship manager is the individual or group responsible for external relationships. The relationship manager is often a sales manager or an account manager.
Administrator—An administrator is an individual or group responsible for providing administrative support to the project. Users with the administrator role may include business administrators, lawyers, and human resources staff.
Staff—staff refers to individuals or groups who carry out the tasks associated with the project. They may be employees, contractors, consultants, temporary employees, vendors, volunteers or others, depending upon the project.
Client—The individual or group for whom the project is performed. Clients may be internal or external to the organization. They may be customers or other stake holders.

As used herein “project” refers to units of work undertaken by teams. Projects may also be called activities, initiatives, efforts, or assignments. Projects are goal-oriented and are intended to produce anticipated results. Projects typically operate within constraints including schedule, level of available resources, regulatory considerations, acceptable processes, and required deliverables. Projects may comprise:
A start date.
An end date, though some projects, for example customer service improvement, may be ongoing, with no defined end date.
A leader, the individual responsible for coordinating the activities of the project.
Objectives or goals, which are usually expressed as an anticipated set of deliverables. The deliverables may change during the course of a project.
Budget and other resources which will be used to perform the project.
Participants, which includes project team members and other individuals working on the project. The participants may be within the organization, for example staff, or outside the organization, for example partners, vendors, contractors, clients and consultants. The participants may be located that the same geographic site or be located at different geographic sites.
A schedule which will usually also include defined tasks, milestones, key dates, and deliverables.

As used herein a “data storage component” refers to a software component for storing and retrieving data. Typically the data storage component will comprise a database such as a relational database, an object-oriented database, or a flat file database.

As used herein a “business rules component” is a software component that enforces the rules, the business rules, defined by the system and by the users of the system. The business rules comprise rules guiding the operation of the system. A portion of the business rules may be modified by users.

As used herein a “user interface component” is a component of the system that is responsible for interacting with the users of the system. The user interface component is adapted to accept user input and display output for the user to examine. Typically the user interface component will comprise a web browser running on a machine capable of executing the browser software. The user interface component may also comprise a software program capable of accepting user input and generating user output other than a web browser. The user interface component will typically be connected to the other components of the system via a wired or wireless network. They user interface component may also run, with the rest of the components of the system, on a single machine. Examples of devices that may support the user interface component include desktop computers, laptop computers, tablet computers, personal digital assistants, and mobile telephones. The input to the user interface component may comprise keyboard input, mouse input, voice input, and stylus input.

As used herein “dashboard” or a “dashboard view” comprises tables displayed on a user interface component. Dashboards display one project per row. Data related to projects may be displayed in user-defined columns. Graphical icons and/or color are used to speed and simplify the comprehension of dashboard data. Dashboard data are selected from the data storage component for display to the user. Dashboards display components or dimensions across multiple projects.

As used herein “component” refers to either a software component of the system or to a portion of a project. Software components comprise the data storage component, the business rules component, and the user interface component. Project components comprise the action item component, goals component, issues component, contacts component, and other components. Project components may also be called elements.

As used herein a “visualization” comprises a graphical representation of project related data. For example pie charts, scatter plots and the like. Visualizations may be dynamic, respond to sliders, other UI elements, adjust parameters of the visualizations. Visualizations may be used to speed comprehension of data, status, and for forecasting or other decision support.

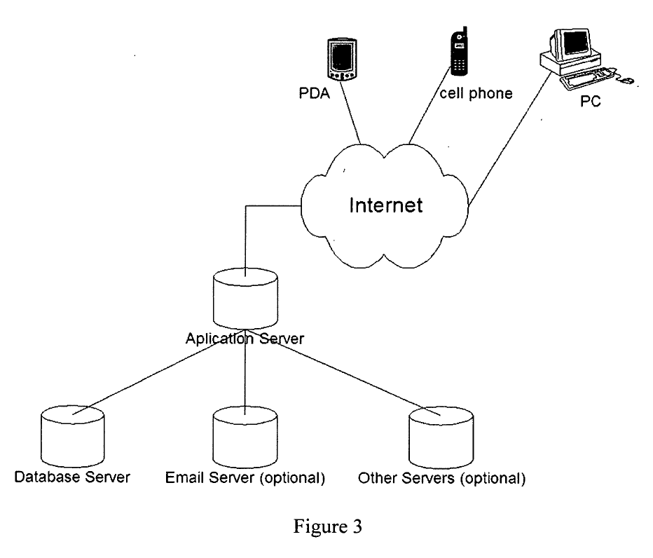

As shown in FIG. 3 embodiments of the invention may be implemented as a web application. Users may be located at the same geographic site or they may be located at different geographic sites. The user interface component of an embodiment of the invention may comprise a computer, personal digital assistant, mobile telephone, or other device that is capable of supporting a web browser or user interaction program. The connection between the user interface component and the other components of the system may be wired or wireless. The information and signals exchanged between the user interface component and the other components of the system may encrypted or unencrypted.

Each user connects to an application server that contains executable code or program software. The first application server may optionally connect to additional servers that may or may not share equipment with the first application server. The additional servers may comprise a data storage server, a database server, an electronic mail server, a document storage server, a contact management server, and other servers.

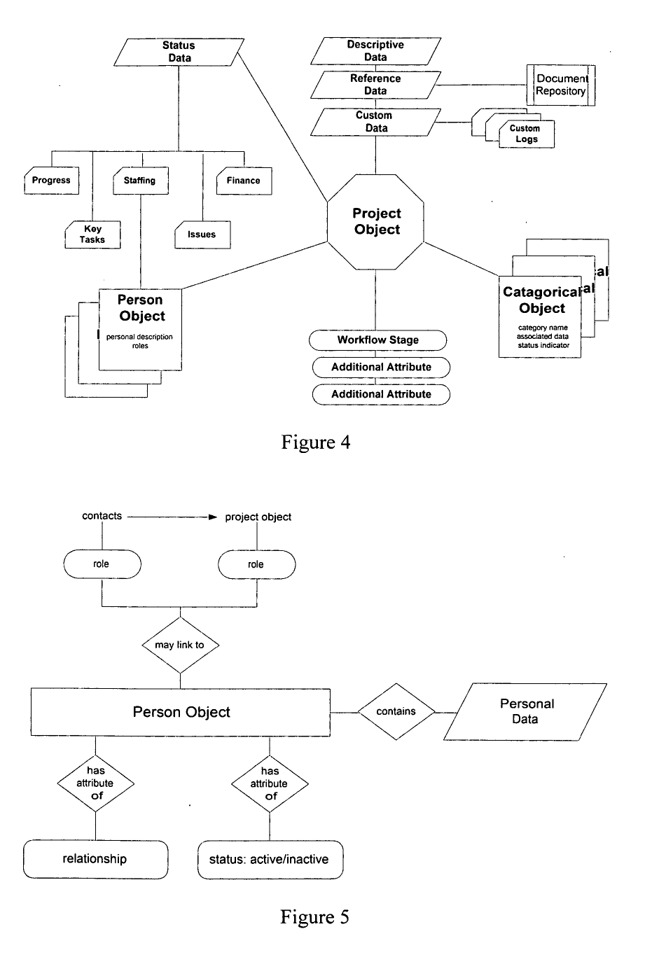

An object-relationship model used by embodiments of the invention is shown in FIG. 4. The model is a series of interrelated data structures that specify the information to be stored for each project. It is a collection of data elements that, taken together, provide a comprehensive view of each project and team. The data structures are designed so that elements of individual projects can be aggregated to provide views across multiple projects.

At the core of the object-relationship model is a data structure called the project object, FIG. 4. Project objects are based upon a project object template that is created by the system administrator during system configuration. An instance of the project object is created for each project entered into the system. The project object is structured to comprise four types of data. The project data comprise descriptive information, reference information, status information, and custom information.

Descriptive information comprises information that defines and characterizes the project, and permits the projects to be partitioned into various clusters. Descriptive information includes the project name and a description of the project. It also includes various attributes that characterize the project.

An attribute comprises an attribute name and attribute values as shown in FIG. 7. The attribute name is chosen by the system administrator or project creator. Attribute values are selected from a list of possible values, typically via a drop-down control, as shown in FIG. 7. The name associated with the control is the name of the attribute while the values appear when the drop-down control is opened. Attributes may be noted as:
Attribute name={value₁, value₂, . . . valueₙ}

For example:
workflow stage={under discussion, proposed, awaiting funding, active, completed, abandoned}
urgency={very urgent, moderately urgent, not urgent}
project type={consulting, design, production, advisory}
project size={small, medium, large}

The workflow stage is a common attribute. In most teams there is a well-defined project workflow cycle. The specific stages in the workflow cycle are defined by the team during project object template creation. For example, a common workflow design would comprise the following stages: under discussion, proposed, awaiting funding, active, completed, abandoned. In this example a project is first discussed, then a plan is proposed and funding is sought, then the project is active, and finally the project is completed. If funding is not obtained the project stage would be changed to abandoned. Moving a project from stage to stage requires that the user navigate to the appropriate screen and select the new stage, typically from a drop-down control. Although workflow stage is not conceptually different from other attributes, it is an element of the business process that is identified as a special element in the project model.

Reference information comprises information that relates to the project and is conveniently accessed through the links to the project object. Reference data are stored in the document storage component of the system. Examples of reference information include:
Documents. There may be many useful documents that are associated with a project, for example specifications, legal documents, contracts, electronic mail messages, and marketing information. Such information may be useful during project reviews. The project object supports links to relevant documents so that they may be viewed or updated as necessary. Reference documents are stored in the document storage component of the system.
Stakeholder Information. Stakeholders are individuals who have an interest in the project.

They may include clients and other individuals external to the team. Because it may be useful to contact stakeholders when decisions are made, the project model allows contact information to be linked to the project object. The contact information is stored in the contact management component of the system.
External Resources. A team may employ external resources to perform some of the projects it undertakes or to perform tasks within a project. These external resources may comprise outsourced projects, vendors, partners, contractors, and consultants. The project model allows information related to such external resources to be linked to the project object.
Terms and Conditions. Different projects may have different terms and conditions under which they are conducted. These terms and conditions may affect project activities as access to information, control of expenditures, how deliverables are to be prepared. The project model allows information related to terms and conditions to be linked to the project object.
Other Reference Material. Teams may have additional reference material that they want to include for their projects. The project object is expandable to allow additional reference material to be linked to the project object.

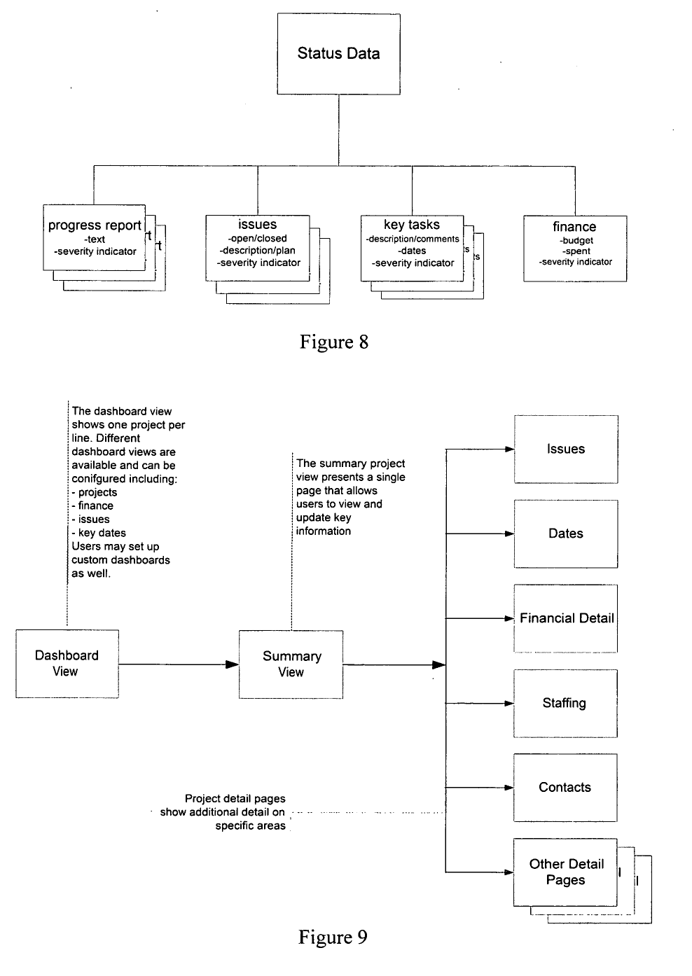

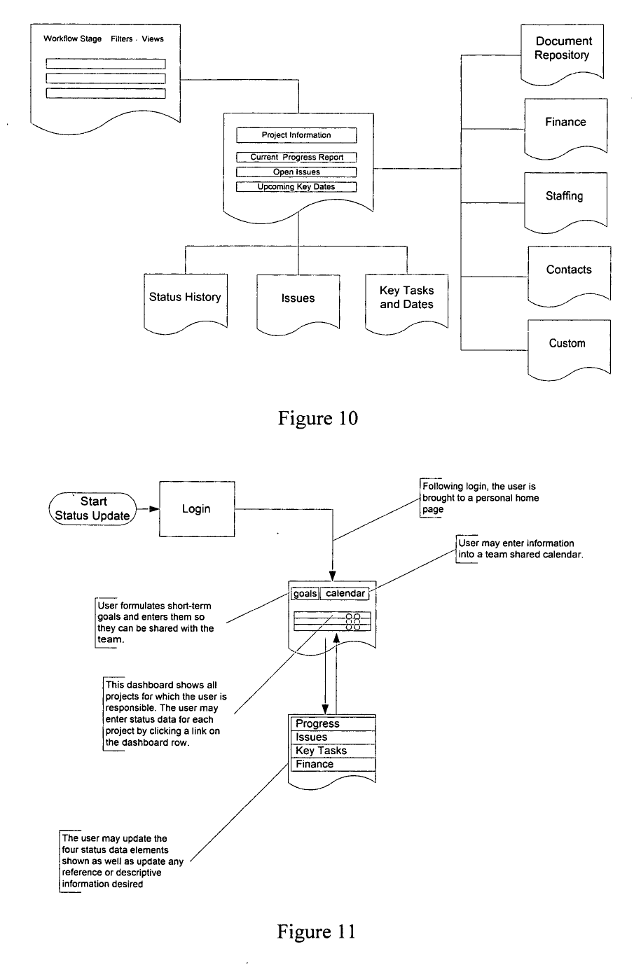

Status information, as shown in FIG. 8, reflects the current status of the project. The information is entered periodically, such as weekly, and when significant events affecting project status occur. Status information comprises:
An overall assessment of how the project is progressing in the form of both a written assessment as well as a state value or a severity value.
Identification of any open issues which need attention. Each issue has an associated explanation, a proposed action, and an associated state value or severity value. Issues may also have associated action items assigned to team members or others.
Identification of the intended project flow in terms of key tasks and associated dates. Key tasks comprise deliverables, milestones, and other tasks that represent a high-level model of the project's task structure and schedule. Each task has an associated state value or severity value. Key tasks may also have associated action items.
Identification of budget expenditures-to-date compared to project workflow stage and overall budget.
Staff assignments that indicate individuals assigned to the project, the roles to which they are assigned, their current workload, their action items and their goals. Their goals are short-term projections of anticipated activities and other information relevant to an individual's availability and priorities. Individuals assigned to the project may comprise employees, contractors, partners, volunteers, consultants, or have other relationships with the team. Information about individuals is kept in a person object linked to project objects. Thus a user can view all person resources associated with a given project.

Custom information comprises any other information that a team uses to perform its tasks. Custom information storage is configured by the system administrator during system setup, or may be established on a project basis. Custom information may comprise notes and journals.

During system setup the system administrator, working with the team, configures project object templates. Project object templates are configured in the preferences section of the system. A team determines what elements are relevant to their assignments. When creating a project object template the team may determine elements comprising:

What reference data should be linked to the project objects.

What terminology should be used

What project attributes should be defined to characterize projects.

What roles should be assigned to individuals associated with projects.

Once a project object template has been defined users may create new instances of a project object from within the system by using the new project wizard. The new project wizard guides users through the process of assembling and entering the information required by the project object template.

Project data are entered by team member users of the system. Typically the project lead will enter the majority of project data. Some data, primarily descriptive data are entered upon project object creation. Other data, for example reference data, are entered when the data become available. Still other information, primarily status information, is entered periodically, for example weekly or whenever the status of the project changes significantly.

Project information or project data are entered via data entry screens comprising the areas of workflow, issues, tasks/action items, and budget. The data are typically entered as short qualitative comments, observations, or concerns. In addition, a state value or severity value may be associated with the entered data. Thus while the data are entered in small, easy-to-conceptualize units, the data form a rich structure that reflects the current status of the project across multiple dimensions, as well as the history of project activity. Individual project objects may be aggregated to provide various views of team progress across multiple projects.

Embodiments of the invention may comprise a person object. The person object comprises data about persons as shown in FIG. 5. Typical person data comprise name, address, title, contact information, competencies, skills, experience, training, reporting relationships, comments, and other information related to the person. In addition the person object comprises information related to the relationship between the person and the team or project such as staff relationship, client relationship, vendor relationship, contractor relationship, consultant relationship, partner relationship, or stakeholder relationship. A person object may comprise multiple relationships. Also the person object indicates whether the person is active or inactive. Inactive persons are not available for assignment to projects.

The person object links to project objects with which the person is associated. An attribute, specifying the relationship, is set. If the person is a staff member, contractor, partner, consultant or vendor or other such person the link is direct. If the person is external such as a client, the link is through the contact object.

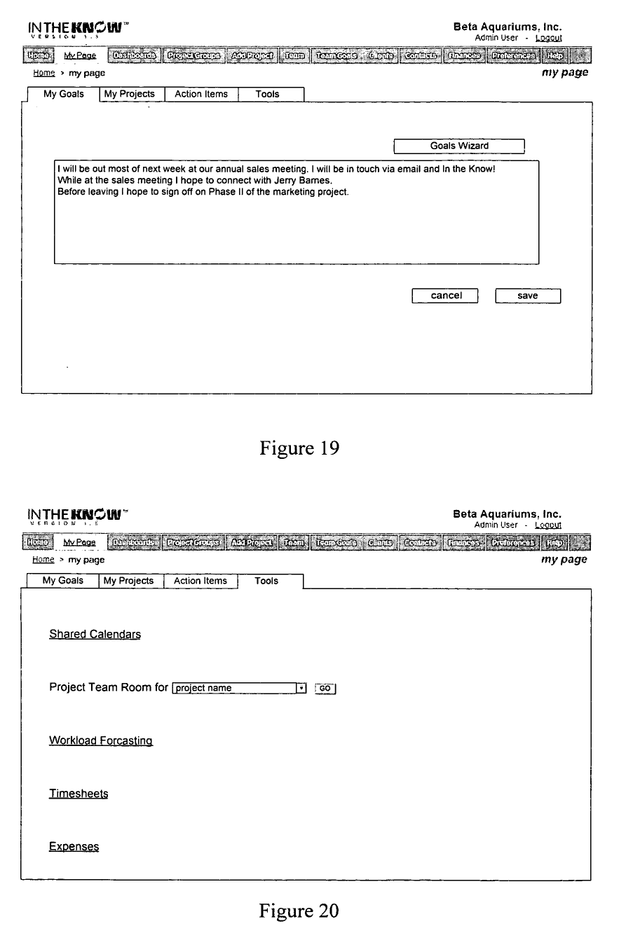

Embodiments of the invention may comprise a goals object. The goals object is linked to the person object and comprises data related to the goals that the individual is pursuing. A user of the system opens the goal data entry screen and specifies goals for upcoming time periods, as shown in FIG. 19. A goals wizard, just in time training, or performance support system may be used to assist the user to learn the preferred method for formulating and entering goals. Time periods used for goals may be weeks, months, quarters, years, or whatever period has been agreed upon by the team. In addition to supporting current goals the system allows review of past goals. Data from past issue resolution and goals may be used to track individual performance and to support coaching and personal development.

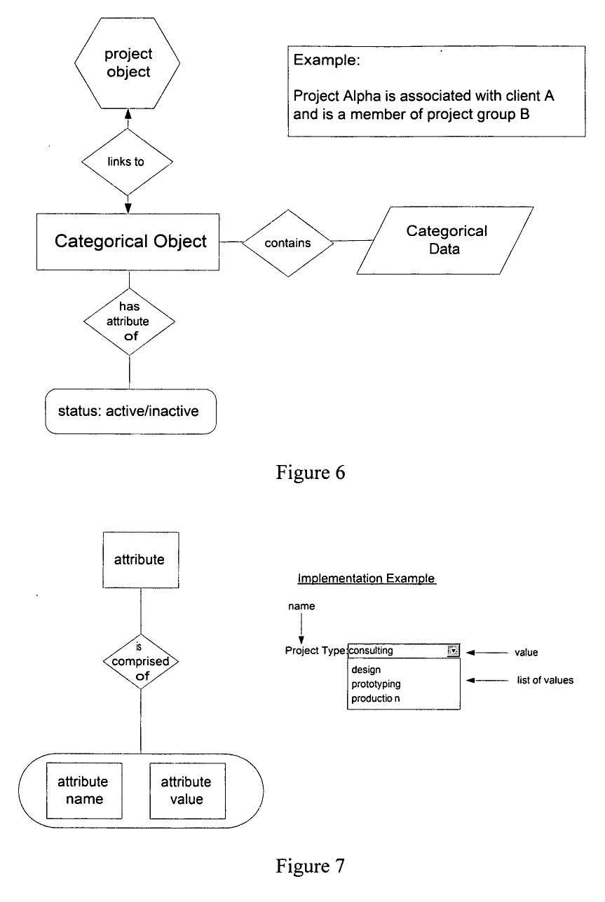

Embodiments of the invention may comprise a categorical or category object. A category object allows projects to be associated with categories as shown in FIG. 6. The most common category objects are client and project group. By associating a project with a client category object it becomes possible to view projects by client. In addition, all client information such as contacts, address information, directions, past history, and financial relationships become available to the project. Category data comprise category name, category value, category status, and category data structure.

Since all project objects have certain attributes in common a view of multiple projects may provide insight into a team's progress as a whole. The user interaction component is adapted to display a dashboard view of projects that allows teams and team leaders to view multiple projects and identify areas that need attention as shown in FIG. 24. Graphic indicators, such as icons, and the use of color speed the understanding of project status. Graphic indicators and the use of color may be used to display severity indicator data in dashboards.

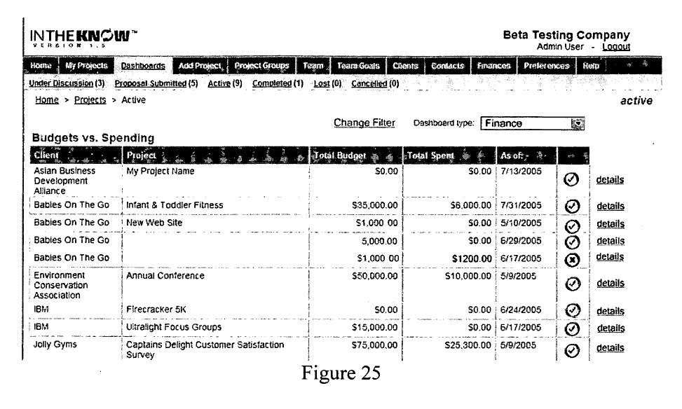

The projects displayed in a dashboard view may be selected via Boolean search logic or other search logic. For example projects displayed on a dashboard may be selected based upon workflow stage, budget, issue severity, or other combinations of project attributes. The expression {workflow stage=“active” AND project type=“consulting”} would select all active consulting projects. Any attribute or combination of attributes may be used to select projects for viewing in a dashboard. The selection criteria may set up as Boolean expressions which are translated into queries by the system. The user may also employ a simple query building interface so that the user need not be familiar with creating Boolean expressions. In addition, the fields selected for viewing in a dashboard may be configured by the user. A financial dashboard view may comprise financial fields as shown in FIG. 25, while a project dashboard may comprise workflow, issues, and milestones fields as shown in FIG. 24.

Embodiments of the invention may comprise a contacts object. The contacts object comprises contact data for external parties relevant to the project. External contacts may comprise clients, contractors, and consultants.

Embodiments of the invention may comprise a milestones object. The milestones object comprises milestones and due dates. Milestones are key deliverables along with the date that the deliverables are due.

Embodiments of the invention may comprise an action items object. The action item data comprise action items which may be elements of a to-do list. Action items may or may not comprise milestones.

Embodiments of the invention may comprise a key dates object. Key dates comprise due dates for milestones, action items, progress reports, and goals.

Embodiments of the invention may comprise a shared calendar object. The shared calendar may be shared among all members of a project team. The calendar helps to build awareness of team milestones, action items, key dates, and deliverables.

Embodiments of the invention may comprise an objectives object. Projects may be linked to objectives to support teams that adopt a management by objectives model.

Embodiments of the invention may comprise a just-in-time training system. The training system assists users as they perform their tasks. For example if a user requires assistance preparing a progress report the training system can provide guidance regarding the preferred format required for a report, the material to be included in the report, and the likely recipients of the report. The training system helps to insure that standard tasks are performed in an approved manner. In addition to training users in the preferred methods for performing tasks the system may also train users in the proper use of the software system.

Embodiments of the invention may comprise wizards for certain tasks. For example when a user is creating a new project the user may invoke a wizard to guide the creation of the new project. Once invoked the wizard will ask the user a series of questions, gather the necessary project information, and finally create the new project. Other wizards comprise a state reporting wizard, a status reporting wizard, and a goals formulation wizard.

### Specific Embodiment

A specific embodiment of the invention is implemented within the program In The Know!™. The program may be embodied on a computer readable medium. The entity-relationship or object-relationship diagram of In The Know!™ is shown in FIG. 4. The objects of the program comprise the project object, the person object, the categorical object, the milestone object, the goals object and the contact object. The program is implemented as a web application and users log in to the system via client computers or other devices capable of running a web browser.

A system administrator, a user with administrative privileges, first installs the system and configures the project object template. The administrative screen is shown in FIG. 13. The template is then used to set up individual projects. The project object template is adapted to receive project data comprising information related to company specific settings, extended features, wording/terminology, user logins, main menu items, workflow, custom attribute dropdowns, staff types, staff roles, and email notifications.

The “company specific settings” menu item allows the administrator to modify the appearance of the home page. The user can set such items as the name of the company, the company logo, the colors and graphics desired. In addition, there are several message areas, which can be configured to display both pre- and post- logon.

The “extended features” menu item allows the administrator to configure certain elements of the business rules. From this menu item the administrator can determine whether the projects are associated with clients, as with a business, or not, as with a non-profit organization. The administrator may also determine whether project grouping is enabled. If grouping is enabled then projects may be clustered in groups, such as consulting projects, programming projects, and construction projects. The administrator determines whether key roles such as project owner, project lead and account manager will be required when projects are created. The administrator determines whether budgets and expenditures are to be displayed, and the administrator specifies the rules by which state indicators are set for key dates.

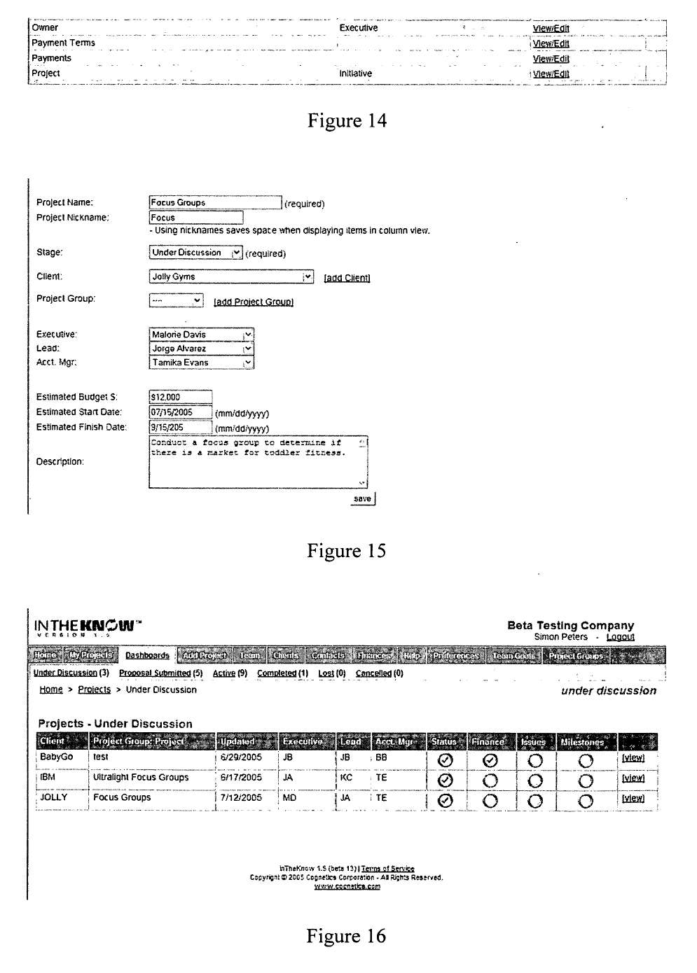

The “wording/terminology” menu item allows the system administrator to change the words that the user interface component presents to the users. FIG. 14 shows a section of the wording/terminology screen on which the term “owner” is replaced with “executive” and the term “project” is replaced with “initiative.”

The “user logins” menu item allows the administrator to create or modify user accounts. When a user account is created the user is assigned to a user class. The user class defines the privileges that the user has when using the system. Users with administrative privileges are permitted to modify the system configuration. Users with management privileges are allowed read/write access to all projects within the system. Users with project privileges are allowed access to the projects to which they are assigned.

The “main menu” item allows the system administrator to change the way the main menu is displayed. The administrator may select different terms for any main menu option, may show or hide any main menu item and can specify the order in which the main menu items are to be displayed. In addition, the system administrator may configure multiple customized main menu buttons, each of which may be linked to other systems via a universal resource locator or URL. Linking to other resources allows the integration of the system with other systems and web sites.

The “project” menu item allows the system administrator to specify the menu of project detail pages that are available for drill down. Each project detail page may be assigned a custom name and may be displayed or hidden. The order in which the pages are displayed in the menu may also be set. In addition, the system administrator may set target URL's for each menu item. Setting menu item URL's allows customization of screens at the detail level.

The “workflow” menu item allows the system administrator to define the workflow stages associated with projects. The administrator defines names and display order for the various stages. Any workflow stage may be set to be visible or hidden.

The “custom attributes” menu item allows the system administrator to set up attributes that can be associated with projects. The name and potential values of the attribute may be defined. the system administrator may also set up categorical attributes which are similar to client and project groups. Each attribute comprises a name-value pair, an active-inactive status, and a link to an associated data structure. Categorical attributes may be updated by any user once they are created by the system administrator. For example, users may add a new client or create a new project group. Users may also set the status of any existing client or project group to active or inactive.

The “staff types” menu item is allows the system administrator to define the staff type attributes that are associated with people objects and will appear in the directory. Staff types may comprise employee, contractor, consultant, vendor, board member, and volunteer.

The “staff roles” menu item allows the system administrator to define the roles that may be associated with people objects when they are assigned to a project. Staff roles may comprise administrator, owner, account manager, staff, team member, advisor, and project lead.

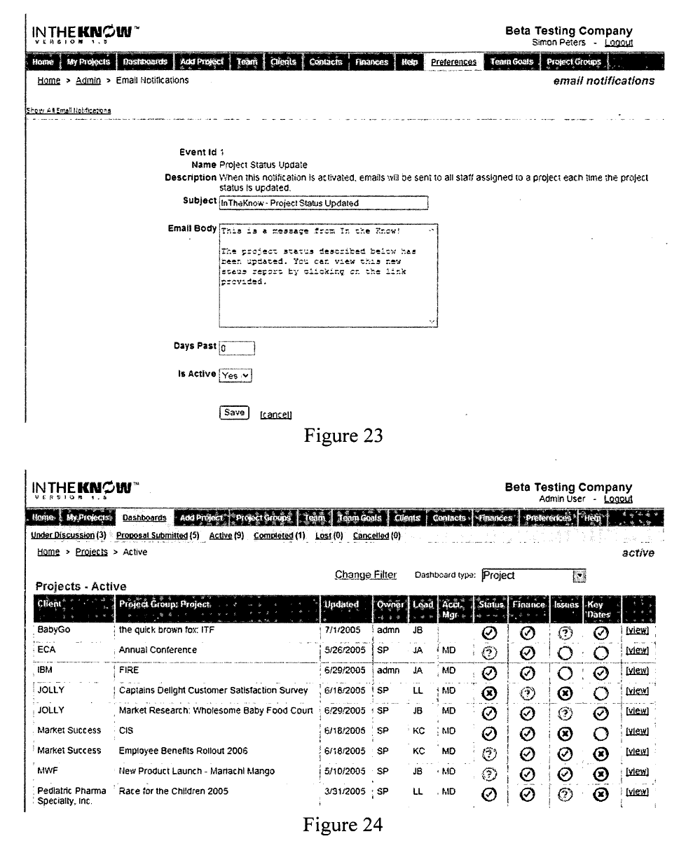

The “email notification” menu item allows the system administrator to define under which circumstances electronic mail notifications are to be sent out and to whom they should be sent. For example all members of a project team should receive notification when a contact is added to a project, or that the project lead should be notified when a status report is overdue. An email notification screen is shown in FIG. 23.

After the system administrator configures the system for use, users must be added to the system. Users are assigned login id's or usernames as well as passwords and permissions. Biometric information or other information to uniquely identify users may also be entered into the system. Other information related to each user is added to the system data base. User information comprises name, address, contact information, role information, skills, and remarks.

Any user who is eligible to assume the role of project owner, project lead, or account manager may create a new project. Creating a project causes the creation of a new instance of a project object. The project object is populated with basic information collected by the new project wizard.

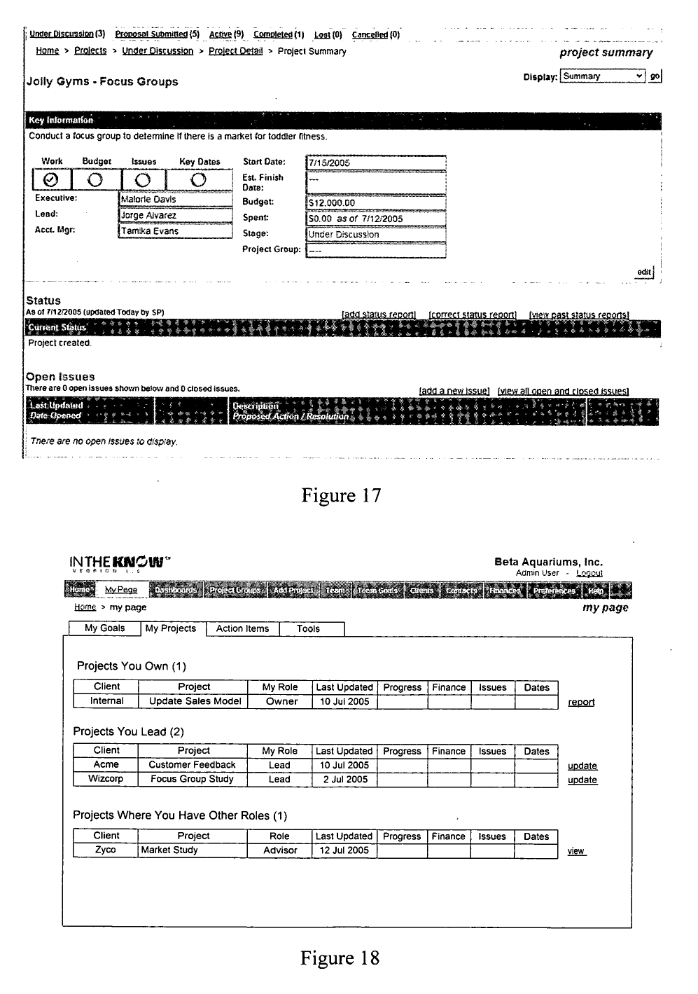

To create a project the user clicks on the “add project” menu item. FIG. 15 shows the add project screen. The user enters the required information. If desired, the user may crate a new client or a new project group. FIG. 17 shows a newly created project with the workflow stage assigned to “under discussion.”

FIG. 16 shows a dashboard where projects at workflow stage “under discussion” have been displayed. There are three projects at this workflow stage. The third project is the newly created project.

FIG. 17 shows the “project summary” page of the project detail. This page is reached by clicking on the “view” link associated with the project in the dashboard view. Navigating to the project summary page is an example of the drill down process. FIG. 17 shows how data captured by the new project wizard are used to populate the newly created project object and how the information is displayed to the user. The user may now, or in the future, add data to the project object by clicking on the appropriate links and entering the data.

Any user who is a member of the management team may modify or add project data. When such modification or additions are made, the data are flagged with the user's identification. Project data may comprise both qualitative data, such as comments, and quantitative data, such as dates. Flagging allows a historical trail of modification to be stored in the data storage component for later retrieval and study.

An activity supported by In The Know!™ comprises updating project status. FIG. 11 summarizes the update process. A user logs in to the system, typically after a validation process, for example by submitting a logon id/password pair, or by biometric identification, or by other identity validation means. Upon login the user's personal home page is displayed as shown in FIG. 18. There are four tabs on the personal home page: my goals, my projects, action items, and tools. The tab labels may be modified by the system administrator.

FIG. 18 shows the appearance of the screen when the “my projects” tab is selected. The user is provided with three dashboards that show projects for which the user is assigned the role of owner, projects for which the user is assigned the role of lead, and projects for which the user is assigned other roles.

The “my goals” tab of the personal homepage allows the user to enter goals as shown in FIG. 19. The user may enter goals directly or may elect to use the goals wizard. The goals wizard is an integrated performance support component that assists the user in formulating goals and provides just-in-time training to improve the user's skills. A historical record of goals is maintained and may be accessed. The historical record is used by management to assist in decision making and workload forecasting. The historical record may also be used by a team leader in performance management. The goals of the entire team are available for review through a main menu item.

The “my tools” tab, as shown in FIG. 20, provides the user with access to a set of tools that support project management. If the user is a project lead or a member of a project team the user may access a project team room that supports team collaboration. The user also has access to shared calendars, timesheets, workload forecasting tools and expense reporting tools. Additional tools may be added by the system administrator.

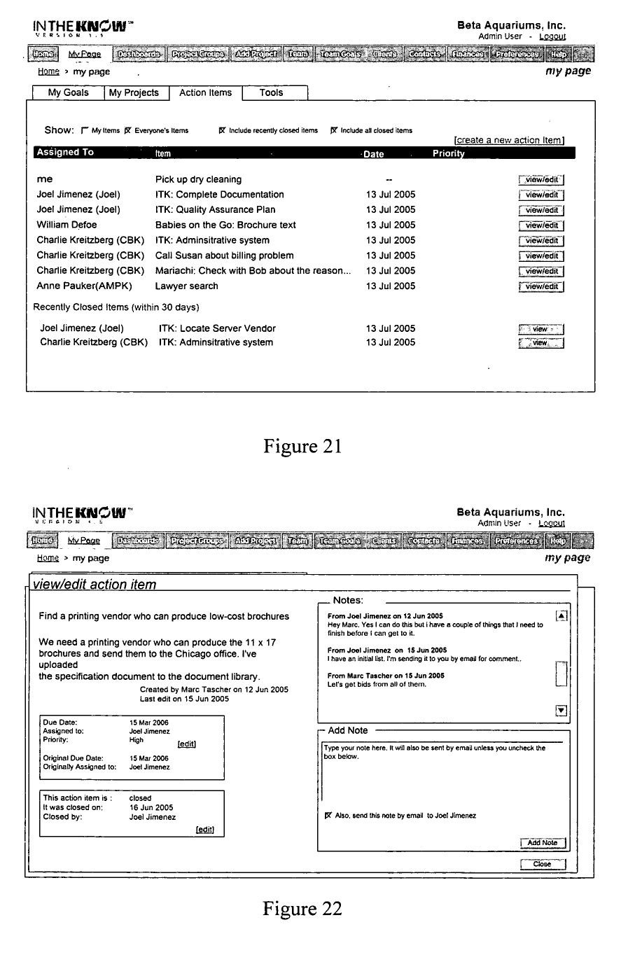

The “action items” tab allows tasks to be assigned to people. The people may be users of the system or other individuals who are not users of the system. As shown in FIG. 21 action items may be attached to issues. They may also be attached to key dates as shown in FIG. 21. Action items allow a project lead to assign specific tasks to one or more individuals. Action items may also be attached directly to a project object. Attaching an action item to a project object allows the project lead to assign action items that are related to a project but not to a specific issue or milestone date.

Action items may also be created that are not associated with any project at all. Such action items might be used if the team wanted to accomplish some task that did not relate to any specific project, issue, or date.

FIG. 21 shows the action item tab on the personal home page. The first action item shown was created outside any project and was self assigned to the user. The remaining actions items are assigned to others. Action items that are prefixed with a project name were created within a project. Action items lacking a project name prefix are freestanding action items created outside any projects. A detailed view of an action item is shown in FIG. 22. The screen is accessed by clicking on the “view/edit” button associated with one of the action items shown in FIG. 21. From the detail screen the user may see the details of the action item, reassign it, post comments on the associated message board, and perform other tasks associated with the action item.

By looking at multiple projects at the same time, users can see the overall state of the projects, identify trends and identify areas needing attention. There are two ways that multiple projects can be viewed, through visualizations and dashboards.

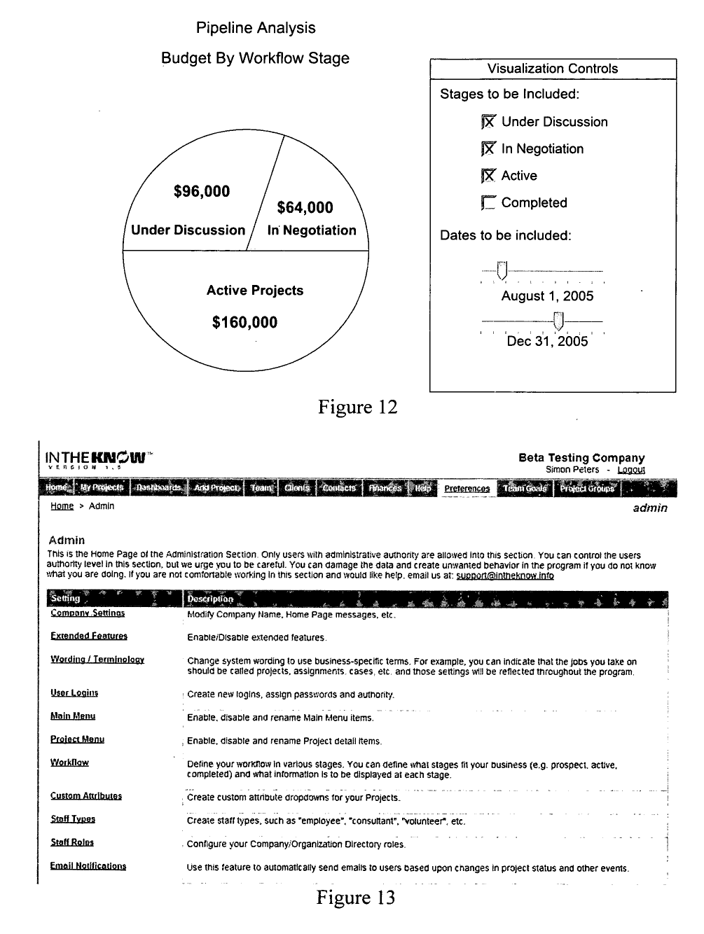

Visualizations are graphic representations of aggregations of the projects, people and other resources. They may be as simple as static graphs but may also be dynamic with user controls that allow the user to adjust parameters and observe the results. An example is shown in FIG. 12.

The user may custom design visualizations and add them to the system as customized displays. Such visualizations have a presentation layer, interactive controls, and a data specification. These elements may be specified as a script or other method and may be added to the system as an administrative function.

A dashboard is a user interface element that shows projects in table format, utilizing graphic symbols and/or color to aid comprehension of project information. Each project occupies a single row of the table. Dashboards are representations of aggregations of projects. An example of a dashboard is shown in FIG. 24. Many parameters may be adjusted to modify the dashboard display, including:
Type of dashboard desired, for example:
   project dashboard
   financial dashboard
   issues dashboard
   key dates (milestones) dashboard
The columns to display
The workflow stage(s) to be included
The project attributes to be included
The sort order

While standard dashboards are defined, users may also define custom dashboards. Custom dashboards might comprise a database query, or a presentation definition.

As FIG. 24 shows, the user may select the type of dashboard to be displayed by selecting it from a drop down list. The dashboard shown in FIG. 24 is a project dashboard. FIG. 25 shows a financial dashboard.

As can be seen from both FIGS. 24 and 25, the user may change the parameters of a filter that determines what projects are displayed by clicking on the “change filter” link. The user may specify Boolean combinations of attributes and variables or can construct customized database queries.

The dashboard provides high level views of multiple projects. Areas, or projects, requiring attention are highlighted by severity indicators. The visual appearance of a severity indicator is a function of the underlying severity indicator value. Severity indicators may comprise graphical indicators, or colored indicators, that identify areas where a team member has identified a concern or where the system itself determines that there is something requiring attention (for example, a key date that has passed).

Projects details are accessed using drill down functionality as illustrated in FIG. 9. Drill down means that information is shown at a high level and the user can “drill down” to view more detail by clicking on the appropriate links. The drill-down process can be repeated until the most detailed level is reached.

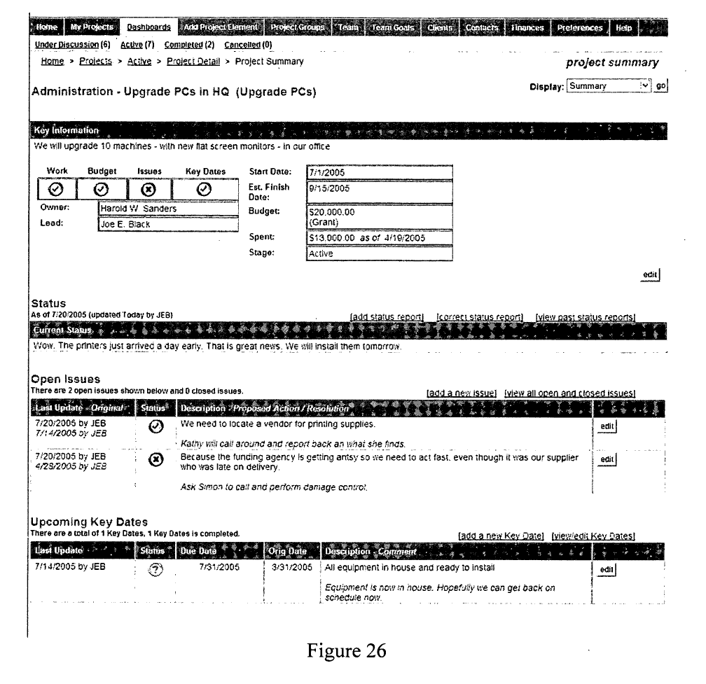

Each project is represented as a series of pages. Drilling down from a dashboard, the first page shown is a Project Summary Page displayed in FIG. 26. The project summary page expands on a dashboard view by presenting a summary of important project information on a single page. This information may include:
Basic project information
Key staff assignments
Budget and amount spent
Anticipated completion date
Project group
Project attributes
Workflow stage
Current status report
Current open issues
Upcoming key dates

The user, if authorized, may review the items listed above and perform such functions as:
Update any of the qualitative or quantitative information shown including project description, dates, key assignments, budget and expenditures, group, and attributes.
Add a new status report.
Correct a current status report.
View past status reports.
Open new issues.
Close issues that have been resolved.
Update the severity indicator values or text associated with issues.
Update the severity indicator values for other components.
Change the due dates for key dates or editing other data in the key date object.

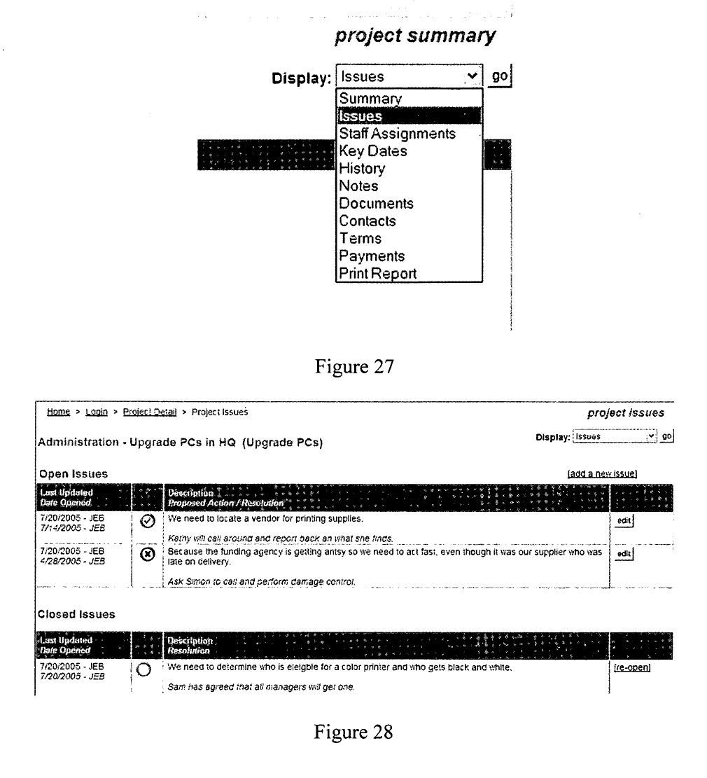

The user, if authorized, may drill down from the project summary screen to project detail screens by selecting the project detail screens from a drop down list as shown in FIG. 27. The list of project detail screens available is set by the system administrator in the configuration area. Project detail screens may include:
Issues (both open and closed) as shown in FIG. 28.

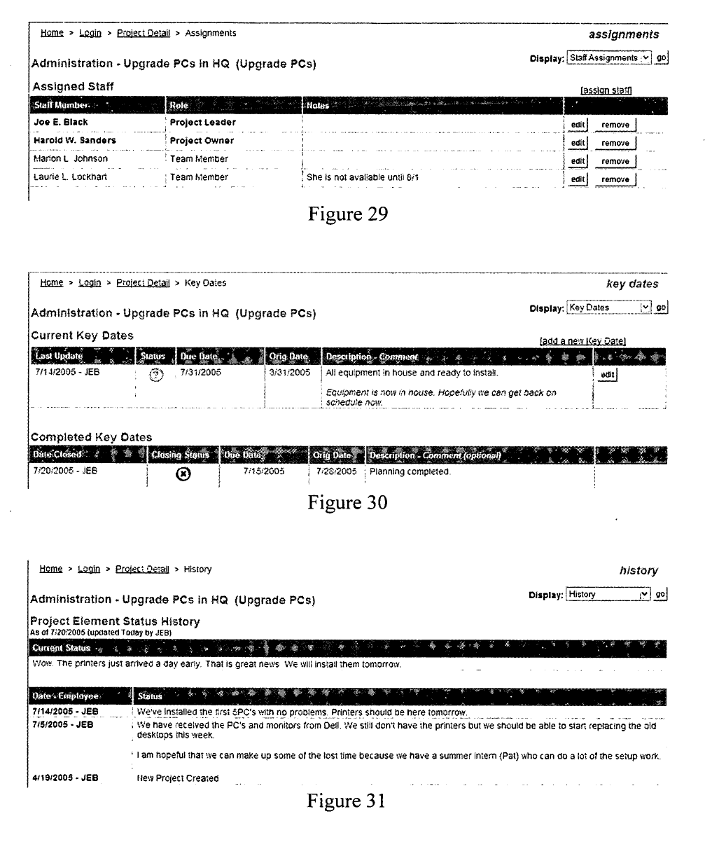

Staff assignments, as shown in FIG. 29 is used to define the key staff assignments for the projects (e.g. owner, lead) and other team assignments. This screen may be used to:
Obtain lists of staff members
Perform workload forecasting for the team
Set up and view shared team calendars
Control access to the team room

Key Dates (completed and upcoming) as shown in FIG. 30.

Status History as shown in FIG. 31

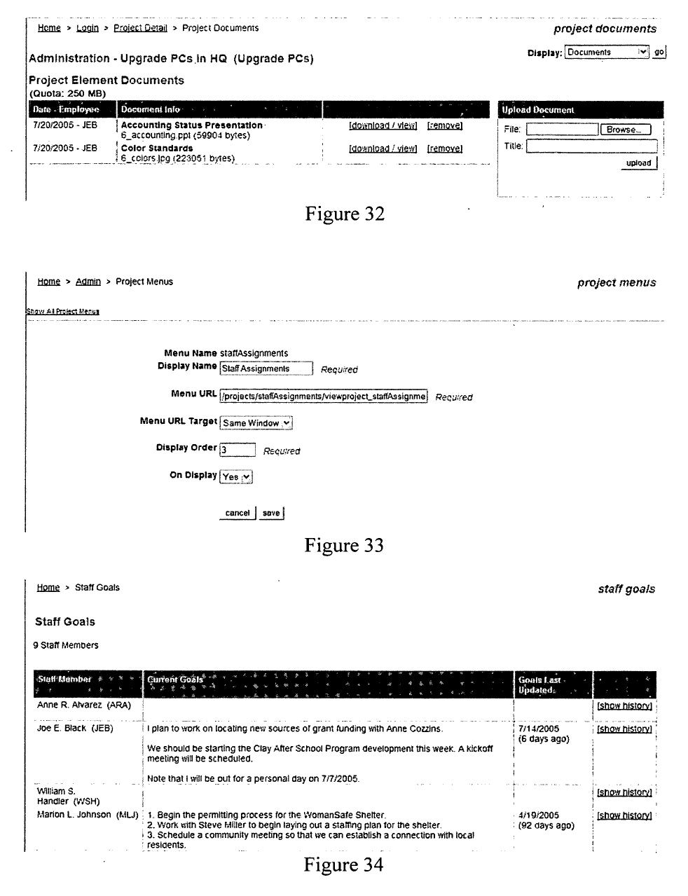

Document repository in which the team may store and retrieve documents and emails as shown in FIG. 32.

In addition to the screens described above there are additional screens that the user can access. The system administrator can configure the project detail menu. The administrator can determine:
What detail screens appear on the menu
The order and names of the detail screens
If additional detail screens or customized detail screens are to be added to the menu

Any detail screen may be replaced by a modified or customized screen by the system administrator as shown in FIG. 33.

The user may update any project in which the user is assigned the role of project lead. Status data comprise progress reports, issue reports, milestones, and financial information. Each status item is associated with a state indicator or severity indicator. Descriptive information related to the project may also be updated. Descriptive data comprise workflow stage, severity indicator value, state indicator value project group category, project leader, project owner, and project account manager. FIG. 22 shows an update screen which allows the user to enter, view, or edit action item information and modify the state indicator if desired.

If instead of project lead the user is the project owner then the “update” link is changed to “report.” The report link has all of the functionality of the update link but also allows the user to create a condensed status report. The user has the ability to concatenate and edit these status reports to create a consolidated status report that reflects the overall status of all the projects for which the user has the owner role. The overall status report may be exported from the system so that higher management may review the status of projects. If the project owner is a member of the higher level team, as with the executive committee shown in FIG. 1, then the report may be exported from the management team project and imported into the higher level team project. The import-export feature allows each team to be treated as a single project within the higher level management team. The import-export process may be applied to an arbitrary number of hierarchy levels.

If a user is not a project lead or project owner then the user may be allowed read access to projects or write access to specific limited areas of projects.

The system includes an email notification and transport capability that enables it to communicate with users and others. Email may be used to send notifications and to allow data exchange. Email transport options are set in the Preferences section, as shown in FIGS. 13 and 23.

Notifications are emails that are sent to individuals or groups. Notifications are defined by the system administrator who determines when an email notification is to be sent, who is to receive it, and what the contents of the email will include.

Typical events that may trigger an email notification include:
Status reports are overdue
Key dates are approaching or past
A status report is updated
A document is added to the repository
A person (team or contact) is updated

as well as other events.

FIG. 23 shows one of the screens where the system administrator may configure the email notification. This screen is reached by selecting Email Notification from the administrative menu shown in FIG. 13 and then navigating to Screen 23.

Email transport can be used for data input and data exchange between different systems. For example the user can:
send an email with an attached document for filing in the document repository
send an email with a vCard attachment to update address information
send a cc: of an email to be filed as part of project documentation

Emails that are associated with projects, such as those shown above, require three data elements so they can be correctly processed. These data elements, along with one embodiment of them are:
The individual who is sending the email. This can be determined by the system from the email address of the sender.
The action to be taken. This can be specified in the subject line of the email
The project. This is specified in the project address. A process for identifying the project is (in one embodiment) as follows:

Each project, person, client, group or categorical object is assigned a unique nickname, or short name. These nicknames are constrained so that they are valid components of an email address. For example, if the project is “A Complete Market Study,” the nickname might be “study.” This can then be used in an email address such as:

study@mycompany.intheknow.info. The system, upon receiving and parsing the email address, can determine the target project.

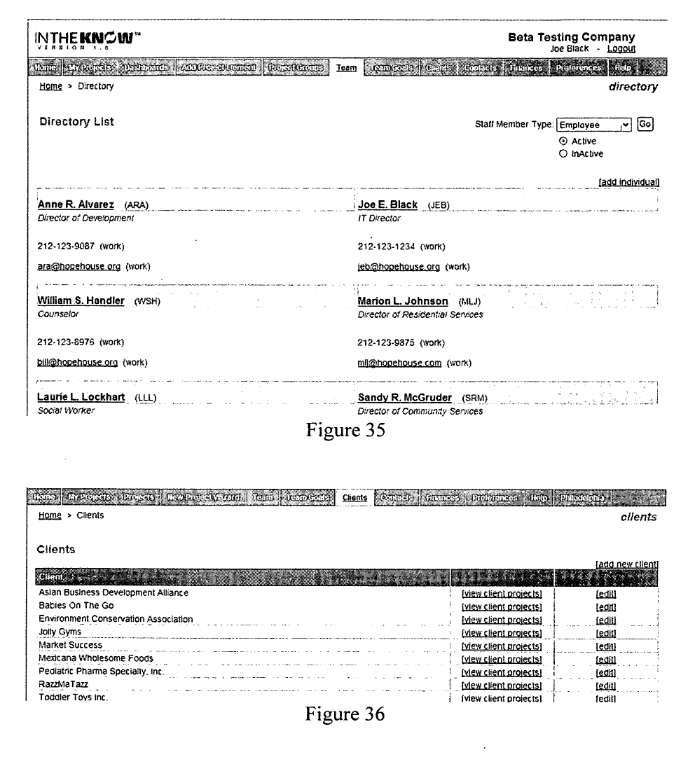

The system maintains a directory of people who have been entered into the system. Team members are shown in a Team Directory as shown in FIG. 35. The system allows multiple categories of team members to be defined. For example: employees, contractors, volunteers, board members, and so forth. Within each class of individual, people may be active or inactive. Only active individuals can be assigned to projects.

A person object is created for each individual in the directory. The object indicates acceptable roles for that individual as well as holding demographic data. There is a separate directory, similar in structure to the team directory, for individuals who are external to the team. The directory is titled the client directory but can be renamed. Clients are attached to projects but may also be viewed independently as shown in FIG. 36.

We claim:

1. A system for managing teams engaged in projects comprising:
at least one template adapted to receive project data;
a data storage component;
the data storage component configured to store project data;
the data storage component configured to store qualitative data;
a business rules component comprising:
workflow tracking;
issue tracking;
action item tracking;
and goal tracking;
a user interaction component capable of displaying information and accepting user input further comprising;
a dashboard for displaying information related to at least one project;
the dashboard comprising graphic symbols;
the dashboard comprising colors.

2. The system of claim one further comprising severity indicators.

3. The system of claim one further comprising drill down functionality.

4. The system of claim one further comprising a just in time training system.

5. The system of claim one further comprising a document storage component.

6. The system of claim one further comprising an electronic mail notification system.

7. The system of claim one further comprising an archiving component.

8. A method of managing teams engaged in projects the method comprising:
Configuring at least one template
the template adapted to receive project data
providing a data storage component;
the data storage component configured to store project data;
the data storage component configured to store qualitative data;
providing a business rules component;
the business rules component adapted to track project workflow;
the business rules component adapted to track issues;
the business rules component adapted to track action items;
the business rules component adapted to track goals;
providing a user interaction component capable of displaying information and accepting user input;
the user interaction component adapted to display a dashboard;
the dashboard comprising graphic symbols;
the dashboard comprising colors;
allowing users to view, edit, and enter data.

9. The method of claim 8 further providing severity indicators;
and allowing users to update severity indicators.

10. The method of claim 8 further providing a drill down functionality;
and allowing users to use the drill down functionality.

11. The method of claim 8 further providing just in time training;
and allowing users to use just in time training.

12. The method of claim 8 further providing a document storage component;
and allowing users to store and retrieve documents in the document storage component.

13. The method of claim 8 further providing an electronic mail notification system;
and allowing users to interact with the electronic mail notification system.

14. The method of claim 8 further providing an archiving component;
and allowing users to interact with the archiving component.

15. A computer program embodied on a computer readable medium for managing teams engaged in projects comprising:
at least one templates adapted to receive project data;
a data storage component;
the data storage component configured to store project data;
the data storage component configured to store qualitative data;
a business rules component comprising:
workflow tracking;
issue tracking;
action item tracking;
and goal tracking;
a user interaction component capable of displaying information and accepting user input further comprising;
a dashboard for displaying information related to at least one project;
the dashboard comprising graphic symbols;
the dashboard comprising colors.

16. The computer program of claim 15 further comprising severity indicators.

17. The computer program of claim 15 further comprising drill down functionality.

18. The computer program of claim 15 further comprising a just in time training system.

19. The computer program of claim 15 further comprising a document storage component.

20. The computer program of claim 15 further comprising an electronic mail notification system.

21. The computer program of claim 15 further comprising an archiving component.
